(19) United States
(12) Patent Application Publication
(10) Pub. No.: US 2005/0112540 A1
(43) Pub. Date: May 26, 2005

(54) Teaching facility with communication device

(76) Inventor: James Whaley, Eugene, OR (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/997,525

(22) Filed: Nov. 24, 2004

Related U.S. Application Data
(60) Provisional application No. 60/524,521, filed on Nov. 24, 2003.

(51) Int. Cl. G09B 7/00

(52) U.S. Cl. 434/365

(57) ABSTRACT

A teaching facility includes a central room or area from which an instructor can teach a plurality of classes. The classrooms adjoin the central room and students within each classroom are positioned to view the instructor in the central room. The teaching facility also includes a communication device with at least one computer teaching board. At least one of the central room and the classrooms include the computer teaching board. The computer teaching board includes a surface on which the instructor can write. Either the board or a stylus used with the board includes an input device feature that senses the writing and conveys an electronic form of the writing to a computer. The computer converts the signal from the input device into machine-readable data. The data preferably is output via one or more output devices, which are networked with the computer teaching board to form at least a portion of the communication device.

### RELATED APPLICATION

This application claims priority under 35 U.S.C. § 119(e) to provisional application Ser. No. 60/524,521, filed Nov. 24, 2003.

### BACKGROUND OF THE INVENTION

1. Field of the Invention

The present invention relates generally to a teaching facility with a communication device. More particularly, the invention relates to a communication device that includes one or more teaching boards on which an instructor can write to teach several classes of students simultaneously, with the writing selectively or automatically being converted into electronic data for storage, revision, distribution or output.

2. Description of the Related Art

As we transition from the 20^{th} century to the 21^{st}, it is time to replace the old icon of teaching: the Chalkboard. Chalkboards and, for that matter, erasable white boards serve as a useful teaching and communication tool in allowing one to express ideas, concepts and thoughts in a written form that a relatively large audience can view. The transfer of information from one person to others in this manner, however, usually requires the audience to listen and record such expressions and writings simultaneously. Consequently, many recipients of such information may misunderstand or completely miss certain aspects of the communicated information because they are concurrently hearing new information and attempting to copy the information that the lecturer has previously written on the board. Additionally, transcription errors can occur between the information written on the board and the information copied onto the individual's paper. The limitations in this form of communicative expression can lead to implementation errors, learning errors, and a general misunderstanding on the part of the recipient of at least some of the information conveyed.

It is also time to replace the standard teaching format: a teacher at the head of the class in front of the chalkboard. For example, in grade school, one teacher typically is in class all day and teaches a variety of subjects, including English, math and science. The teacher thus must be well versed in such diverse subjects and must have obtained his or her teaching credentials. Accordingly, less educated and/or experienced personnel cannot serve in the traditional teacher role.

### SUMMARY OF THE INVENTION

A computer teaching board can replace the old standard teaching tools—the chalkboard and wipe board—to improve the accuracy of the information conveyed. Thus, in an educational setting, the computer teaching board would eliminate the necessity of note taking and would allow students to concentrate on the lesson.

As such, a preferred mode of the present communication device comprises at least one computer teaching board having a surface on which one can write. Either the board or a stylus used with the board includes an input device feature that senses the writing and conveys an electronic form of the writing to a computer. The computer converts the signal from the input device into machine-readable data. The data also can be edited or supplemented by using the input device feature of the board or stylus, or by another input device, such as, for example, by typing on a keyboard. The data preferably is output via one or more output devices, such as, for example, by printing and/or emailing the file containing the data, and/or by displaying the data on displays that are disposed in the room with the computer teaching board and/or in adjacent or remote rooms for simultaneous instruction. For example, the computer teaching board can include a display that is disposed next to or is integrated with the writing surface for displaying the data, for sending and receiving messages or other information (e.g., downloaded graphics), and/or for displaying audio-visual files used in connection with the lecture, to name a few exemplary uses for such a display.

The communication device, which includes one or more of the teaching boards, can be employed in a teaching facility in which a plurality of classrooms are adjoined to a central area. The central area allows one instructor to teach the students in the plurality of classrooms, and the teaching board allows the instructor to effectively communicate the lesson to one or more students in the classrooms.

### BRIEF DESCRIPTION OF THE DRAWINGS

The foregoing and other features, aspects and advantages of the present communication device are described in detail below with reference to drawings of a preferred embodiment of such a device, which embodiment is intended to illustrate and not to limit the invention.

FIG. 1 illustrates a schematic view of a computer teaching board in accordance with a preferred embodiment of the present invention.

FIG. 2 is a schematic block diagram of various components of the computer teaching board of FIG. 1.

FIG. 3A is a schematic plan view of an embodiment of a teaching facility in which the computer teaching board of FIG. 1 can be used.

FIG. 3B is a schematic plan view of another embodiment of a teaching facility in which the computer teaching board of FIG. 1 can be used.

FIG. 3C is a schematic plan view of an additional embodiment of a teaching facility in which the computer teaching board of FIG. 1 can be used.

### DETAILED DESCRIPTION OF THE PREFERRED EMBODIMENT

The following describes a preferred embodiment of a teaching facility with a communication device that can be used for instructional and educational purposes. The communication device also can be used as a tool for explaining or memorializing expressible ideas, concepts and thoughts, and/or as a tool for developing tangible ideas, concepts and thoughts. While the present communication device is herein described as comprising a board used in a unique classroom setting, this is just one application of the communication device that can be used in a variety of different venues (e.g., in meeting rooms) and for a variety of different purposes.

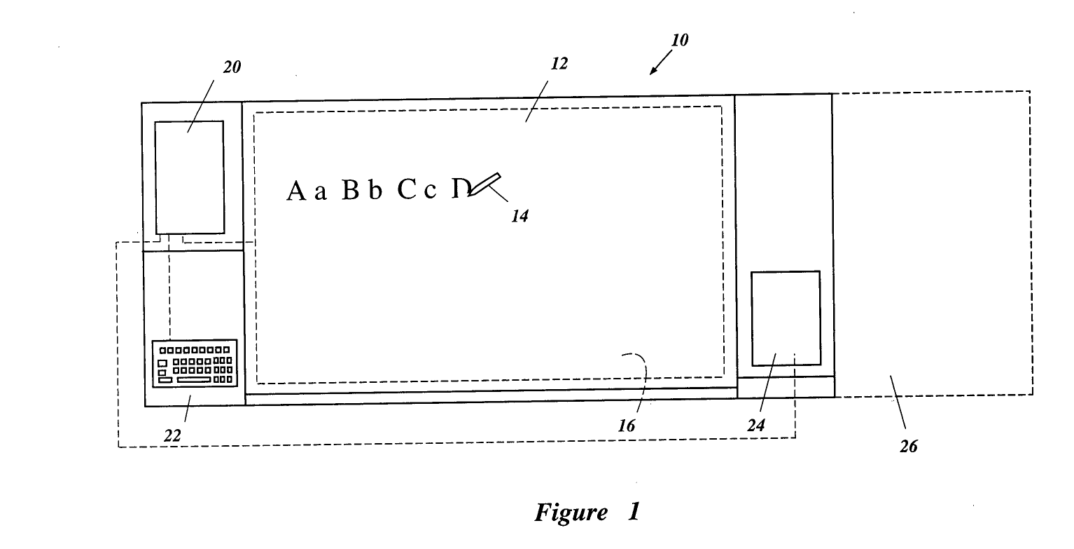

With reference to FIG. 1, the communication device includes one or more computer teaching boards 10. Each computer teaching board 10 includes a writing surface 12 on which a user can write text, graphics, equations, etc. The writing surface 12 preferably is a flexible whiteboard-type surface; however, other types of materials or coatings can also be used as the writing surface.

An instructor or teacher uses a stylus 14 to “write” on the writing surface 12. In the preferred embodiment, the stylus 14 preferably is a dry-erase ink pen, but can take the form of other writing instruments, such as, for example, chalk, wet-erase ink pens, charcoal and the like. In some forms of the computer teaching board, the stylus 14 can be a non-writing instrument where an underlying display is used to depict the writing produced by movement of the stylus over the writing surface.

An input device cooperates with either the writing surface 12 or the stylus 14. In the illustrated embodiment, the input device comprises a touch screen 16 that lies behind the writing surface 12; however, depending upon the type of touch screen used, the touch screen can be disposed in front of the writing surface 12. Various types of touch screen technologies can be used as the input device, such as, for example, but without limitation, resistive, capacitive, and surface acoustic wave.

In the preferred embodiment, a resistive touch screen 16 underlies the writing surface 12. The resistive touch screen comprises a glass panel or other suitable substrate that is covered with a conductive and a resistive metallic layer. Spacers hold the two layers apart. A cover overlies the two layers and the substrate. In some forms, a front side of the cover can either wholly or partially form the writing surface 12. An electrical current passes through the two layers while the board 10 is energized. When a user touches the writing surface 12, the two layers make contact at the point where the stylus (e.g., pen) contacts the writing surface 12. The change in the electrical field is noted and the coordinates of the point of contact are output as one or more electrical signals.

In the illustrated embodiment, the touch screen 16 has generally the same size as the writing surface 12. The touch screen 16, however, can be either larger or smaller than the writing surface 12. For example, the touch screen 16 can occupy half of the writing surface 12 to provide a space for non-electrically convertible writing and/or to reduce the manufacturing cost of teaching board 10. Additionally, the board, including the writing surface 12 and the touch screen 16, can be made of multiple smaller units rather than one large unit, depending on the particular application.

The computer teaching board 10 also includes a computer 18 and preferably one or more auxiliary input devices 20. In the illustrated embodiment, the auxiliary input device comprises a keyboard 22; however, other types of input devices (e.g., a mouse) can also be used. The auxiliary input device(s) 22 communicates with the computer 20 either via hard wiring or via transmitted signals (e.g., infrared, radio frequency, etc.).

The instructor can edit the captured version of the writing on the board (i.e., the data file) using either the auxiliary input device 20 or the primary input device (that is, the board and stylus). In the illustrated embodiment, the instructor can erase captured writing by inputting a command using the touch screen 16 that the computer 20 will understand as indicating that the particular writing should be deleted. By way of an example, the computer 20 can be programmed to erase text in the data file when the instructor underlines the corresponding text on the writing surface 12 followed by one tap on the writing surface. In this manner, the board 12, stylus 14 and touch screen 16 can be used to erase and edit one or more portions of the corresponding data file in the computer 20.

At least one output device 24 also communicates with the computer 20. The output device in the illustrated embodiment is a printer connected to the computer 20. Again, the connection can be done using hard wiring or using wireless technology.

As seen in FIG. 1, the computer teaching board 10 can also include one or more modular additions 26. In the illustrated embodiment, the modular addition 26 is a display that communicates with either the computer 20 and/or with another computer or a network. The display is used to display messages or other information, prior or existing writings on the writing surface 12, or visual and/or audio-visual files (e.g., files in a DVD format) that can be used to supplement the lesson. Additionally, some instructors prepare class notes ahead of time, and these could be scanned and printed or downloaded into the student computers.

FIG. 1 also illustrates a preferred arrangement of the above-described components of the computer teaching board 10. By way of example only, the computer teaching board can have a writing surface 12 with a height of four (4) feet and a width of eight (8) feet. A panel or cabinet module having a width of two (2) feet and a height of four (4) feet is disposed on one side of the writing surface 12. The cabinet is sized and configured to support the keyboard 22 and the computer 20. With the advent of digital photography and the use of memory cards, the computers preferably can be equipped with a port or other input slot for downloading photos. A similarly sized cabinet flanks the other side of the writing surface 12 and supports the printer 24. The modular addition 26 (which can be an LCD display) preferably has the same height as the other components of the computer teaching board 10. As so arranged and correspondingly sized, the teaching board 10 presents an integrated and proportional appearance.

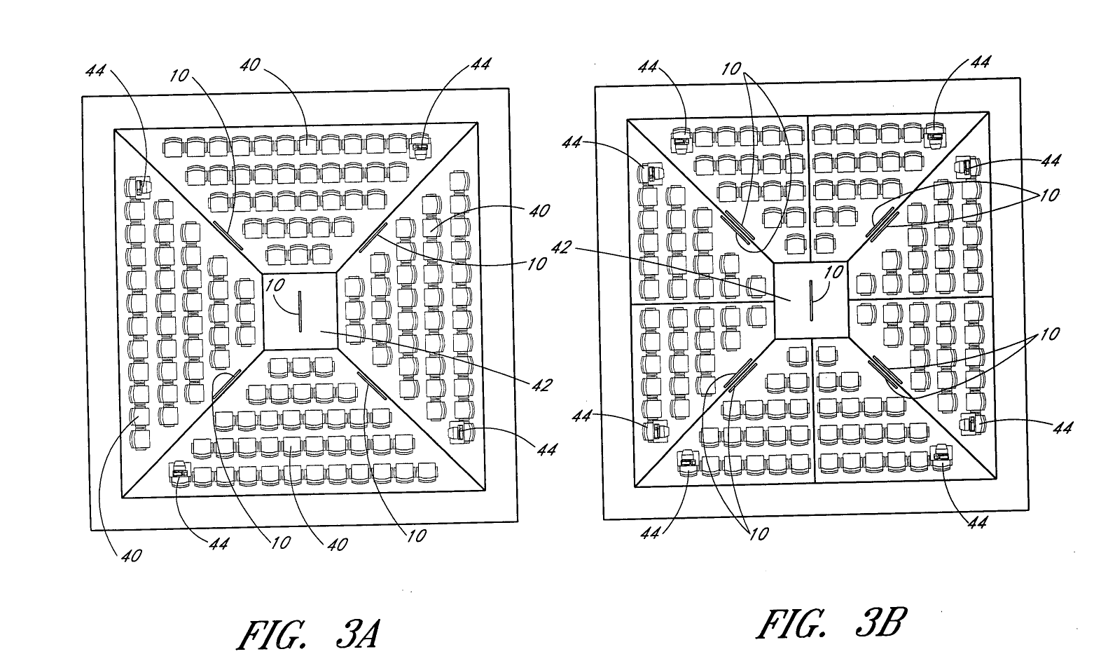

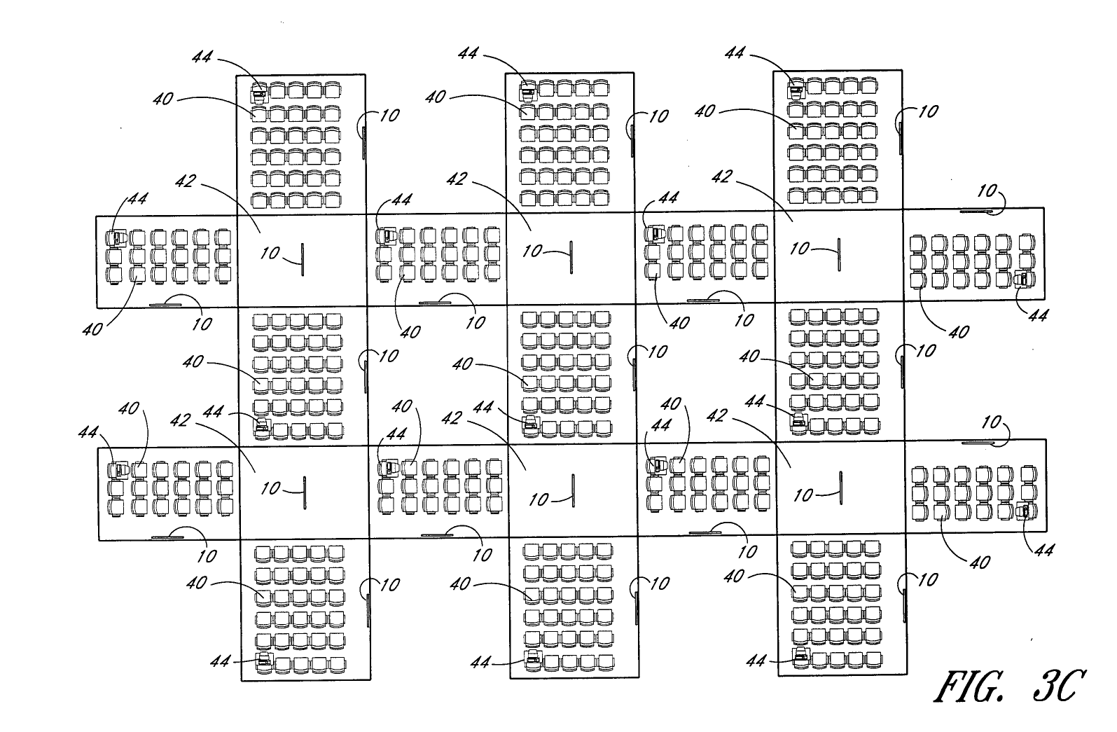

In some applications, the teaching board 10 can be equipped with a display located a side of the board 10 opposite of the writing surface 12. For example, the opposite side of the board 10 can support a flat panel screen (e.g., a LCD or plasma screen) of a size substantially equal to the writing surface 12. The text or formulas written on the writing-surface side of the board 10 will thus appear on the opposite side of the board 10. Consequently, this two-sided embodiment of the teaching board 10 can be used where the instructor's audience is position in front and in back of the board 10, such as in the teaching facility layouts described below in connection with FIGS. 3A, 3B, and 3C.

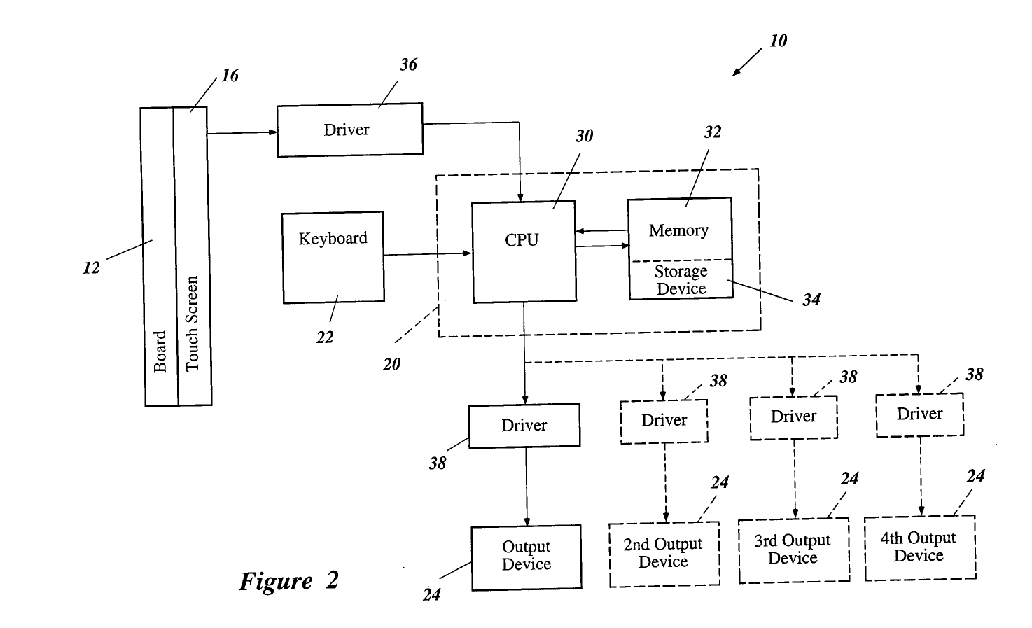

With reference now to FIG. 2, the computer 20 preferably includes a central processing unit (CPU) 30 that includes one or more microprocessors. The microprocessor(s) of the CPU 30 communicates with various other components of the computer 20 including memory 32 as well as at least one storage device (e.g., a hard disk) 34. The memory 32 preferably comprises non-volatile and volatile memory. The non-volatile memory and/or the storage device can store an appropriate operating system, applications (executable programs) and data files. Such executable programs desirable include one or more handwriting recognition and conversion software, such as, for example, JOT® available commercially from Communication Intelligence Corporation, or Graffiti® commercially available from PalmSource. Additional software can be stored that switches between a drawing mode and a handwriting translation mode.

A driver 36 acts as an interface between the touch screen 16 and the CPU 30. The output signals from the touch screen 16 are transmitted to the driver 36. The driver converts the signals (preferably analog) into a machine-readable signal (preferably digital). The CPU 30 receives the output signal from the driver 36 which digitally indicates (i.e., is indicative of) the location of the tip of the stylus 14 on the writing surface 12.

Either the signal from the touch screen 16 to the driver 36 or the signal from the driver 36 to the CPU 30 can be selectively provided in at least some modes of operation. For example, the teaching board 10 can include a switch that an instructor will activate when the instructor wants to capture writings on the board; however, in another mode of operation, the switch is turned to an inactive position. A student's practicing of alphabetic letters or math calculations thus do not need to be translated by the computer and be stored or outputted as a data file. In other applications, the computer converts all writings when the teaching board is energized.

When the CPU 30 receives the compatible signal from the driver 36, it converts the signal into machine recognizable letters, graphics or other instructions using suitable translation/conversion software. This information is then provided as an input into an executable program, such as, for example, but without limitation, Word® or Microsoft® Notepad. Other programs that are especially designed to display formulae, equations or symbols (e.g., chemical symbols or molecule chains) can also be used.

One or more output devices 24 can then display the signal from the executable program (e.g., the signal from Word). A suitable output driver 38 processes the output signal before the output device 24 receives the signal.

The process steps of the drivers 36, 38 preferably are implemented within software modules (programs) that are executed by one or more general-purpose computers. The software modules may be stored on or within any suitable computer-readable medium. It should be understood that the various steps could alternatively be implemented in-whole or in-part within specially designed hardware. Additionally, while the drivers 36, 38 are illustrated as being disposed outside of the computer 20, this has been done for illustration purposes only. The hardware and software of the drivers preferably form part of the computer 20.

Various types of output devices can be used with the teaching board 10. In the illustrated embodiment, the output device 24 comprises a printer; however, LCD displays, projectors, CRT screens, data storage devices (e.g., removable flash memory), networks (e.g., the internet) and the like can be used.

One or more of such output devices 24 can be located in the same room as the writing surface 12 or can be located at a remote location. For example, as seen in FIG. 1, the printer 24 is located next to the writing surface 12 and is integrated into the overall form of the teaching board 10. The output device 24, however, can be a dedicated display located at each student's desk or station in the classroom, can be a computer display on a general purpose computer located at the student's desk or station, or can be a projector or another larger display located within the classroom. In addition or in the alternative to the one(s) located in the classroom, one or more such output devices 24 can be located in adjacent or remote classrooms to allow for simultaneous teaching.

As apparent from the above description, the computer teaching board 10 uses software that allows written information on a large board to be transferred into printable and/or individually viewable text. The material on the board can be edited and corrected, saved, printed or erased. This means no more laborious note taking since important information can be printed and handed out.

The teaching board 10 can be expanded with the addition of “add ons.” For example, the large screen display 26 can be used to show teaching materials, plus movies, office-initiated notices, etc.

The computer teaching board 10 can be used in a manner that radically alters the way children receive instruction in any particular subject. For instance, rather than having one teacher in a class room all day, the children could receive instruction from “master teachers” in a particular subject. Each master teacher would teach one subject (e.g., mathematics, English, science, etc.). Since the “master teacher” could teach several classes at once, the class room could be organized differently than the current model. As seen in FIG. 3A, rooms 40 could be grouped around a central room 42 where the master teacher would be situated. The central room 42 preferably includes a teaching board 10 upon which the master teacher can write. These writings are then displayed to the students, which can be viewed on the teaching board display within each classroom 40, on one or more displays arranged in the central room 42 (one or more of which can be integrated with the teaching board 10), or on displays viewable by a smaller number of students (e.g., on an individual computer screen). In a preferred embodiment, each classroom 40 preferably would have its own teaching board 10 or a large display and the students in each room 40 would be arranged to see the master teacher when teaching from the central room 42. Additionally, the teaching board 10 in the central room 42 is of the two-sided type described above.

In each individual classroom 40, an assistant teacher or student intern can replace the role of the traditional teacher since master teachers would teach all core work. The assistant teacher would conduct and grade tests and would provide individual correction and guidance to the students in their class room 40.

Each classroom 40 preferably has at least one computer 44 and more preferably has a computer 44 for each of the students in the classroom 40. These computers 44 and the teaching boards 10 preferably are networked together to allow for communication among all of the devices on the network.

While FIG. 3A illustrates four (4) rooms 40 surrounding the central room 42, additional or fewer rooms 40 can be connected to the central room 42, as FIG. 3B illustrates, and can be arranged in other configurations, as FIG. 3C illustrates. Additionally, the seating in each class room 40 can be easily changed and/or the individual seats and desks can rotate to allow the students to easily direct their attention to the speaker in the central room 42, to speakers in different central rooms (as seen in FIG. 3C), and to the speaker or the computer teaching board 10 in the individual class room 40. In some embodiments, the seating can be arranged in a stadium layout such that the students at the back of each class can easily see the instructor in the central room 42.

The communication device also preferably allows the students to ask questions to the master teacher in a convenient and organized manner. This feature of the communication device can operate independent of the teaching boards 10 or can be integrated with one or more of the teaching boards 10. For example, a student can type a question using the student's individual computer 44. The question is transferred to the teaching board 10 in the central room 42 and is then displayed for the master teacher to read. The question can also be delivered to the teaching boards 10 in all of the classrooms 40 to be viewed by the other students or to the individual computers 44 of the other students. In this manner, a student can freely ask his or her question without fear of speaking before the group, the questions can be communicated without interrupting the master teacher, the master teacher can address the questions in the order that best fits with the lesson plan, and all of the students can know the question the master teacher is answering.

The communication device also can include one or more gate devices that operate on the network at least between the question sender and the display devices (e.g., the classroom teaching boards 10 and/or the individual computers 44) that the other students read. The gate device can operate automatically to screen the questions for inappropriate terms or phrases and can include logic to detect similar questions such that only one of like questions gets communicated to the other students and possibly to the master teacher. Alternatively, these functions can be manually performed by one or more of the assistant teachers who review the questions before passing them on to the master teacher and the other students.

Alternative ways of expressing the question to the master teacher can be used as well. For example, all questions communicated to the master teacher can be converted into an audible form that the master teacher can hear through a headset. An audible, tactile or visual indicator can also alert the master teacher that one of the students has a question and then the question can be communicated through one of the above-described methods. Such an indicator may also identify the student's seat or name so that the master teacher can identify the student if the question needs clarification.

For younger students and for all other students who have not learned to type, the questions can be converted into electronic data for communication over the network. In one embodiment, an assistant teacher in each room can type the question into one of the computers 44 on the network of the communication device. In other embodiment, the student can ask the question verbally and a speech conversion device, which is part of the network, can convert the verbal question into a written question that the communication device can transmit to the master teacher. The master teacher can then read or hear the question in one of the above-described manners.

Although this invention has been disclosed in the context of a certain preferred embodiment and variations thereof, it will be understood by those skilled in the art that the present invention extends beyond the specifically disclosed embodiments to other alternative embodiments and/or uses of the invention and obvious modifications and equivalents thereof. In particular, while the present communication device and teaching facility has been described in the context of particularly preferred embodiments, the skilled artisan will appreciate, in view of the present disclosure, that certain advantages, features and aspects of the device may be realized in a variety of other applications, many of which have been noted above. Additionally, it is contemplated that various aspects and features of the invention described can be practiced separately, combined together, or substituted for one another, and that a variety of combination and sub-combinations of the features and aspects can be made and still fall within the scope of the invention. Thus, it is intended that the scope of the present invention herein disclosed should not be limited by the particular disclosed embodiments described above.

1. A teaching facility comprising:
a central area from which an instructor can teach;
a plurality of classrooms each adjoining the central area such that students in each classroom can view the central area; and
a communications device comprising at least one teaching board being disposed in at least one of the classrooms and the central area, the teaching board comprising a surface on which the instructor can write, either the teaching board or a stylus used with the teaching board including an input device that senses the writing and conveys an electronic form of the writing to a computer, the computer being configured to convert the signal from the input device into machine-readable data, and at least one output device configured to communicate the writing in a human-readable form to at least some of the students in at least one of the classrooms.

2. The teaching facility of claim 1, wherein the output device comprises a display of a size visible by the students in the classroom.

3. The teaching facility of claim 1, wherein the output device comprises individual computers that communicate with the computer of the teaching board.

4. The teaching facility of claim 3, wherein each individual computer is configured to display emails to the student sent by the instructor.

5. The teaching facility of claim 3, wherein each individual computer includes a display screen and each individual computer is configured to display the writing on the teaching board to a student viewing the display screen.

6. The teaching facility of claim 1, wherein the output device comprises a printer connected to the computer.

7. The teaching facility of claim 1, wherein the teaching board additionally comprises an editing device that communicates with the computer in a manner permitting the data received by the computer to be edited or supplemented using the editing device.

8. The teaching device of claim 7, wherein the editing device comprising a keyboard.

9. The teaching facility of claim 1, wherein the teaching board additionally comprises a display.

10. The teaching facility of claim 9, wherein the teaching board additionally comprises an audio output device.
